(19) United States
(12) Patent Application Publication
(10) Pub. No.: US 2018/0345606 A1
(43) Pub. Date: Dec. 6, 2018

(54) COMPOSITE COMPONENT

(71) Applicants: HONDA MOTOR CO., LTD., Minato-ku (JP); NIHON PLAST CO., LTD., Fujinomiya-shi (JP)

(72) Inventors: Yu NAKASHIMA, Wako-shi (JP); Takanori OHNUMA, Wako-shi (JP); Tomoya MARUYAMA, Fujinomiya-Shi (JP); Tatsuhiko NAKAMURA, Fujinomiya-Shi (JP)

(73) Assignees: HONDA MOTOR CO., LTD.; NIHON PLAST CO., LTD.

(21) Appl. No.: 15/992,665

(22) Filed: May 30, 2018

(30) Foreign Application Priority Data
May 31, 2017 (JP) 2017-107950

(51) Int. Cl. B29C 70/46; B29C 65/00; B29C 70/54

(52) U.S. Cl. CPC B29C 70/46; B29C 65/002; B29C 70/541; B29C 66/72

(57) ABSTRACT

A composite component is a composite component to be fixed to another component. The composite component includes: a first member formed of a first material, and a second member formed of a second material different from the first material, the second member a part of which is covered with the first member. The second member includes a protruding portion protruding in a convex shape from the first member. The protruding portion includes a fixing portion which is provided at least in a part of the protruding portion and to which the other component is to be fixed.

### CROSS REFERENCE TO RELATED APPLICATION

This application is based upon and claims the benefit of priority from the prior Japanese Patent Application No. 2017-107950 (filing date: May 31, 2017), the entire contents of which are incorporated herein by reference.

### BACKGROUND

### Technical Field

The present invention relates to a composite component including a first member and a second member formed of a first material and a second material.

### Related Art

Conventionally, as a structure used for a vehicle such as an automobile, there has been a structure fixed to another structure or the like being another component. For example, a steering hanger beam (steering member) is projectingly provided with a fixing portion fixed by using a floor tunnel and the like and bolts and the like (see JP H8-67272 A (pages 3 to 4, FIG. 5)).

In such a structure, after the casting, secondary processing such as drilling or tapping is required in the fixing portion, and the productivity is not satisfactory. In addition, in recent years, for the purpose of weight reduction, a composite component in which a part is replaced with another material is sometimes used as a structure, but in the configuration including a fixing portion to be fixed to another structure with bolts and the like as in JP H8-67272 A (pages 3 to 4, FIG. 5), when the composite component is formed, the die structure for casting becomes complicated and larger in the position of the fixing portion.

Thus, a configuration is known in which a part of a steel component, for example, separately formed is covered with a magnesium alloy, and a portion not covered with the magnesium alloy of the steel component as a fixing portion is made fixable to another component by welding (see Japanese Unexamined Patent Application Publication (Translation of PCT Application) No. 2013-500165 (pages 4 to 8, FIGS. 1 to 6)).

### SUMMARY

However, in the case of the above-described composite component, it is not easy to position the steel component during insert forming, and it is necessary to form the steel component holding structure into a die.

The present invention is made in view of the above circumstances, and it is an object of the present invention to provide a composite component capable of easily insert-forming other members while coping with weight reduction and capable of easily fixing other components.

A composite component according to one aspect of the present invention is a composite component to be fixed to another component. The composite component includes: a first member formed of a first material, and a second member formed of a second material different from the first material, the second member a part of which is covered with the first member. The second member includes a protruding portion protruding in a convex shape from the first member. The protruding portion includes a fixing portion which is provided at least in a part of the protruding portion and to which the other component is to be fixed.

The second member may include a recessed portion on a back surface side of the protruding portion.

The composite component may be a composite component for a vehicle.

In a composite component according to one aspect of the present invention, making the first material that constitutes the first member for covering a part of the second member made of the second material a lighter material allows the weight of the composite component to be reduced. Then, providing the second member a part of which is covered with the first member with the protruding portion protruding in a convex shape from the first member allows the second member to be sandwiched and positioned by the forming die during forming, and the second member to be easily insert-formed without complicating the shape of the forming die. Furthermore, since including a fixing portion provided at least in a part of the protruding portion exposed from the first member, the fixing portion for fixing the other component, the protruding portion can fix the other component to the second member easily and with high degree of freedom.

In the case of providing the recessed portion on the back surface side of the protruding portion of the second member, the second member can be more easily sandwiched and positioned by the forming die during forming, and the second member can be more easily insert-formed.

### BRIEF DESCRIPTION OF DRAWINGS

FIG. 1 is a perspective view showing a composite component according to a first embodiment of the present invention;

FIG. 2 is a cross-sectional view showing the composite component;

FIG. 3 is a perspective view showing a state in which the composite component is fixed to another component;

FIG. 4 is a cross-sectional view showing a die for casting the composite component;

FIG. 5 is a cross-sectional view showing a method for manufacturing the composite component;

FIG. 6 is a cross-sectional view showing a process following the process in FIG. 5 of the method for manufacturing the composite component;

FIG. 7 is a cross-sectional view showing a process following the process in FIG. 6 of the method for manufacturing the composite component;

FIG. 8 is a cross-sectional view showing a process following the process in FIG. 7 of the method for manufacturing the composite component;

FIG. 9 is a cross-sectional view showing a process following the process in FIG. 8 of the method for manufacturing the composite component;

FIG. 10 is a cross-sectional view showing a composite component according to a second embodiment of the present invention;

FIG. 11 is a cross-sectional view showing a composite component according to a third embodiment of the present invention;

FIG. 12 is a cross-sectional view showing a composite component according to a fourth embodiment of the present invention;

FIG. 13 is a cross-sectional view showing a composite component according to a fifth embodiment of the present invention; and

FIG. 14 is a perspective view showing a second member of the composite component.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Description will be hereinbelow provided for embodiments of the present invention by referring to the drawings. It should be noted that the same or similar parts and components throughout the drawings will be denoted by the same or similar reference signs, and that descriptions for such parts and components will be omitted or simplified. In addition, it should be noted that the drawings are schematic and therefore different from the actual ones.

In the following, the configuration of a first embodiment of the present invention will be described with reference to the drawings.

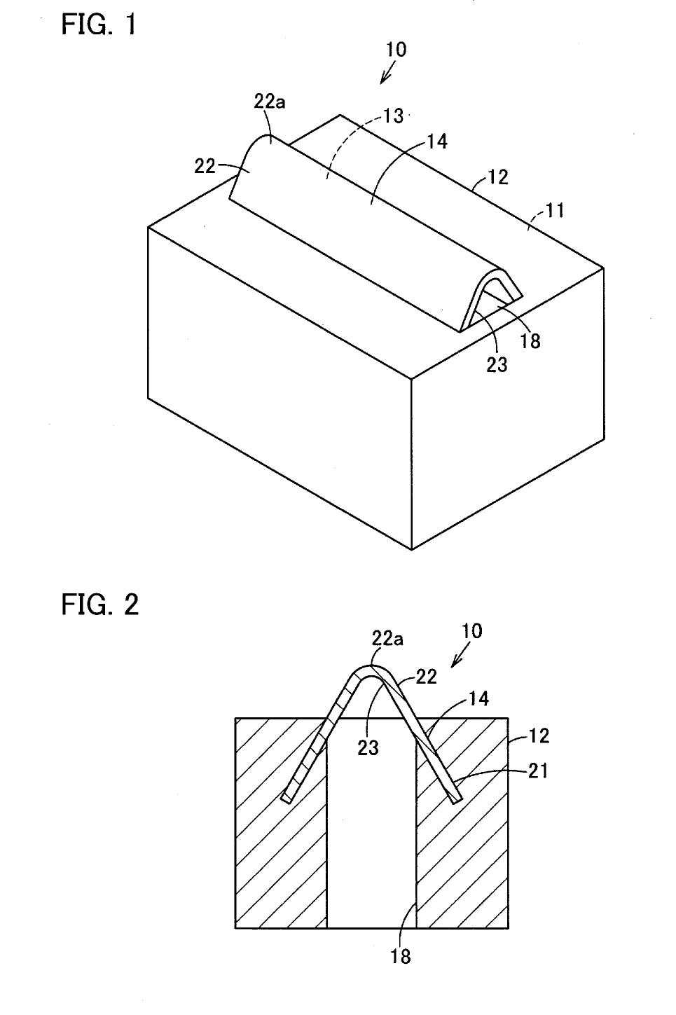

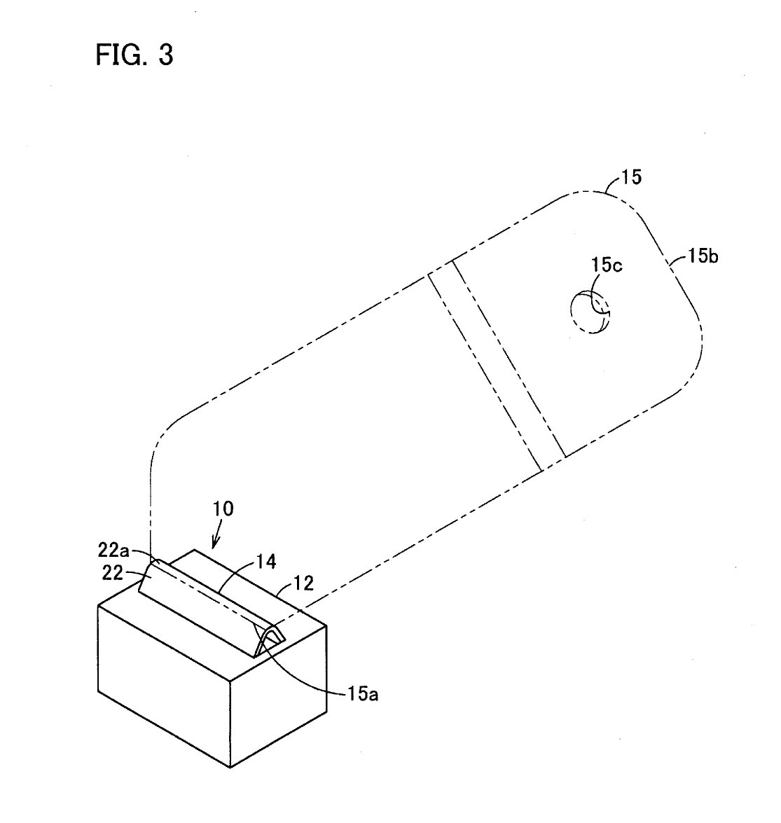

The composite component 10 in FIGS. 1 to 3 is for a vehicle such as an automobile. The composite component 10 is suitably used as any vehicle structure such as a steering hanger beam (steering member), a suspension arm, or a strut tower bar.

In addition, the composite component 10 integrally includes a first member 12 formed of a first material 11 and a second member 14 formed of a second material 13 different from the first material 11. Furthermore, the composite component 10 is fixed to another component 15. Then, the composite component 10 is formed, for example, by casting using a forming die 16.

As the first material 11, a metal material lighter than, for example, the second material 13, that is, for example, a magnesium alloy in the present embodiment is used.

The first member 12, which may also be referred to as a composite component main body, serves as a main part of the composite component 10. The first member 12 is formed by casting the first material 11. The shape of the first member 12 can be set to any shape according to the required shape of the composite component 10. In addition, in the first member 12, a hole portion 18 is formed in a position corresponding to the back surface side of the second member 14.

As the second material 13, a weldable metal material such as steel (iron) is used.

The second member 14 is an insert member formed separately from the first member 12. The second member 14 may be formed by, for example, press forming or the like. The second member 14 includes a covering portion 21 covered with the first member 12 in the composite component 10 and a protruding portion 22 protruding from the first member 12. In addition, the second member 14 may be provided with a recessed portion 23 to be described below. It should be noted that in the present embodiment, the second member 14 is formed of a plate material.

The covering portion 21 is a portion to be embedded in the first member 12 in the composite component 10. This covering portion 21 is a planar portion in the present embodiment. The covering portion 21 may be provided with an anchor hole for allowing the molten metal to pass through during forming (casting) of the first member 12.

The protruding portion 22 is a portion exposed from the first member 12 in the composite component 10 and fixed to the other component 15. It should be noted that the protruding portion 22 in the present embodiment is a portion to be welded to the other component 15. The protruding portion 22 is a bent portion in the second member 14. The tip portion of the protruding portion 22 serves as a fixing portion to be fixed to the other component 15. It should be noted that in the present embodiment, this fixing portion is a welding portion 22a to be welded to the other component 15. For example, the welding portion 22a is linearly provided over a predetermined length along the tip portion, that is, the ridgeline of the protruding portion 22. Then, the protruding portion 22 is a portion to be clamped by the forming die 16 during forming of the composite component 10.

The recessed portion 23 is a portion positioned on the back surface side of the protruding portion 22. In the present embodiment, the recessed portion 23 is positioned over the entire back surface side of the protruding portion 22. The recessed portion 23 is provided linearly along the tip portion of the protruding portion 22 on the back surface side of the tip portion of the protruding portion 22 over a predetermined length. The recessed portion 23 is a portion to be clamped by the forming die 16 during forming of the composite component 10. That is, the protruding portion 22 and the recessed portion 23 are sandwiched from above and below by the forming die 16 during forming of the composite component 10. It should be noted that the second member 14 of the composite component 10 according to the present embodiment is described with respect to a configuration example including the recessed portion 23, but for example, when the second member 14 includes a bar or the like as an insert member, the recessed portion 23 may be unnecessary. That is, the recessed portion 23 is not an indispensable component.

The other component 15 can have any shape, and it is, for example, an elongated plate member bent in an L shape. The other component 15 can be formed of any material as long as the other component 15 can be fixed to the second member 14, and it is formed of a weldable metal such as steel (iron), for example. In addition, the other component 15 is provided with a welding portion 15a to be welded to the welding portion 22a of the protruding portion 22 of the second member 14 in one end portion. Furthermore, the other component 15 is provided with a connecting portion 15b to be connected to another structure or the like in the other end portion. The connecting portion 15b may be provided, for example, in a planar shape. In addition, the connecting portion 15b may be provided with a hole portion 15c to which a bolt or the like is fastened.

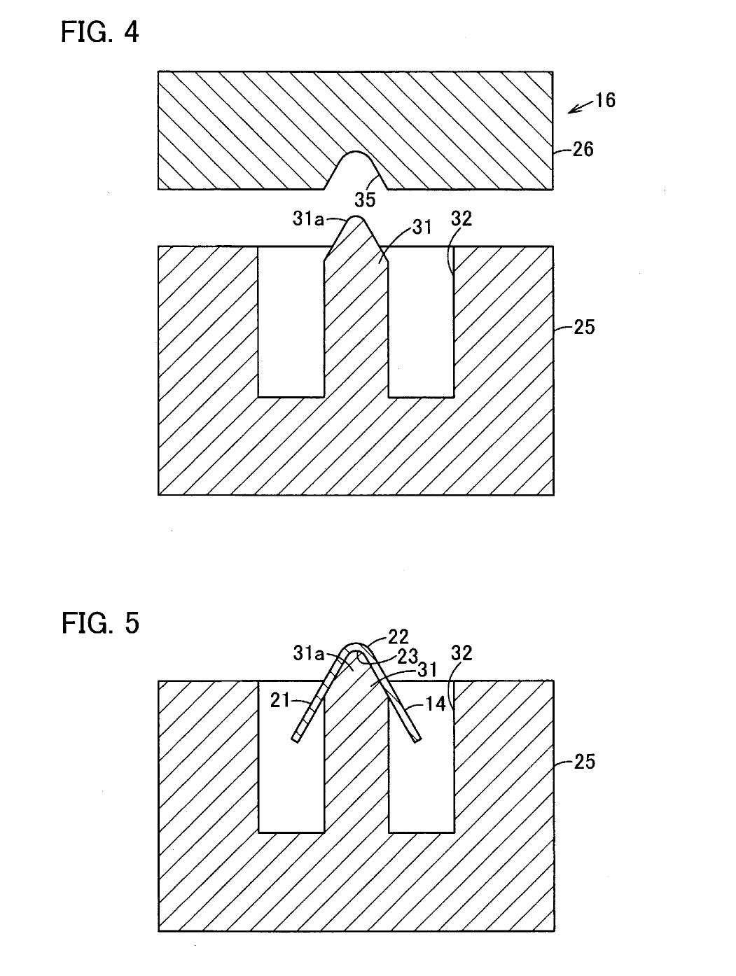

Then, the forming die 16 shown in FIGS. 4 to 9 is a die for casting in the present embodiment. The forming die 16 includes a first die main body 25 and a second die main body 26. Then, the forming die 16 is configured to partition the cavity 27 being a space portion between the first die main body 25 and the second die main body 26 when these first die main body 25 and second die main body 26 are closed.

The first die main body 25 includes a first holding portion 31 for holding the second member 14 during forming (casting) the composite component 10. In addition, the first die main body 25 is provided with an injection portion 32 in a recessed manner which forms the cavity 27 and into which the molten metal is injected during forming (casting) the composite component 10. In the present embodiment, the first die main body 25 serves as, for example, a fixed die.

The first holding portion 31 is provided in a column shape protruding from the injection portion 32, for example. The tip portion of the first holding portion 31 serves as a fitting portion 31a to be fitted into the recessed portion 23 of the second member 14, for example, during forming (casting) of the composite component 10. In the present embodiment, the fitting portion 31a is provided in a mountain shape along the shape of the recessed portion 23. The first holding portion 31 serves as a clamping portion for clamping the second member 14 between the first holding portion 31 and the second die main body 26. Then, the position of the first holding portion 31 is formed as the hole portion 18 of the first member 12 by forming (casting) the composite component 10.

The injection portion 32 is recessed according to the shape of the first member 12. In the injection portion 32, the covering portion 21 of the second member 14 is arranged during forming (casting) of the composite component 10.

The second die main body 26 clamps the second member 14 between the second die main body 26 and the first die main body 25 during forming of the composite component 10. The second die main body 26 is provided with a second holding portion 35 in a recessed manner for fittingly holding the protruding portion 22 of the second member 14. The second holding portion 35 is provided in a position facing the first holding portion 31 of the first die main body 25. In the present embodiment, the second die main body 26 serves as, for example, a movable die.

Then, when the composite component 10 is formed, first, the second member 14 separately formed in advance is set to the first holding portion 31 of the first die main body 25 (FIG. 5). At this time, fitting the fitting portion 31a of the first holding portion 31 into the recessed portion 23 allows the second member 14 to be stably held by the first die main body 25. In this state, both side portions of the second member 14 to be the covering portion 21 extend into the injection portion 32 to be positioned.

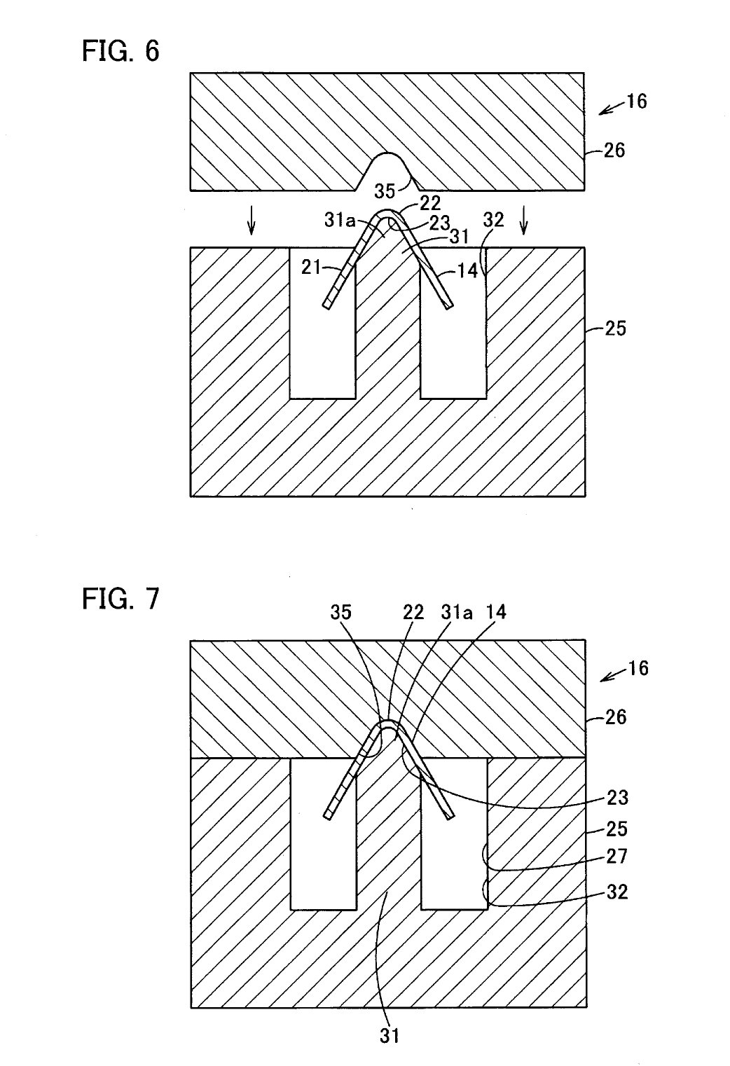

Next, the second die main body 26 is closed to the first die main body 25. At this time, fitting the protruding portion 22 of the second member 14 at the second holding portion 35 causes the second holding portion 35 and the first holding portion 31 to sandwich The protruding portion 22 of the second member 14 from the protruding side and the opposite side (for example, vertically) (FIGS. 6 and 7). Thus, the second member 14 is accurately positioned and held with respect to the cavity 27 formed between the first die main body 25 and the second die main body 26.

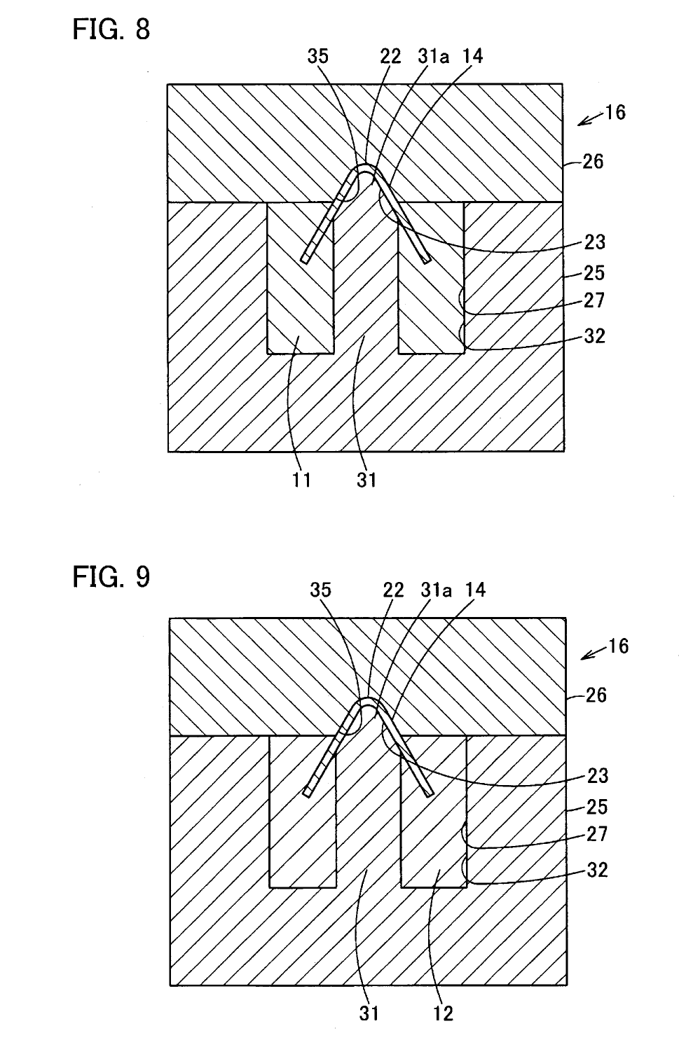

In this state, the cavity 27 is filled with the molten metal of the first material 11 (FIG. 8). At this time, both side portions to be the covering portion 21 of the second member 14 are buried in the molten metal. Then, solidifying the molten metal forms the first member 12 along the shape of the cavity 27 to form the composite component 10 (FIG. 9). As a result, the first member 12 covers a part of the second member 14 (covering portion 21), and the composite component 10 is formed so that the protruding portion 22 (and the recessed portion 23) of the second member 14 is exposed from the first member 12.

Thereafter, the composite component 10 released from the forming die 16 is fixed to the other component 15 welding the welding portion 15a of the other component 15 along the welding portion 22a of the ridgeline of the protruding portion 22 of the second member 14 protruding from the first member 12.

As described above, according to the first embodiment, making the first material 11 that constitutes the first member 12 for covering a part of the second member 14 made of the second material 13 (covering portion 21) a lighter material, for example, magnesium or the like allows the weight of the composite component 10 to be reduced. In addition, providing the second member 14 a part of which (covering portion 21) is covered with the first member 12 with the protruding portion 22 protruding in a convex shape from the first member 12 allows the second member 14 to be sandwiched and positioned by the forming die 16 during forming, and the second member 14 to be easily insert-formed, without complicating the shape of the forming die 16 such as providing the forming die 16 with a sliding mechanism or the like. Furthermore, making at least a part of the protruding portion 22 exposed from the first member 12 as the welding portion 22a for fixing (welding) the other component 15, allows the other component 15 to be fixed to the second member 14 easily and with a high degree of freedom without special secondary processing (such as drilling and tapping) after casting of the composite component 10.

In addition, providing the recessed portion 23 on the back surface side of the protruding portion 22 of the second member 14 allows the second member 14 to be more easily sandwiched and positioned by the forming die 16 during forming, and the second member 14 to be more easily insert-formed.

Furthermore, when the composite component 10 is for a vehicle, the manufacturing cost of the vehicle can be reduced while coping with weight reduction of the vehicle.

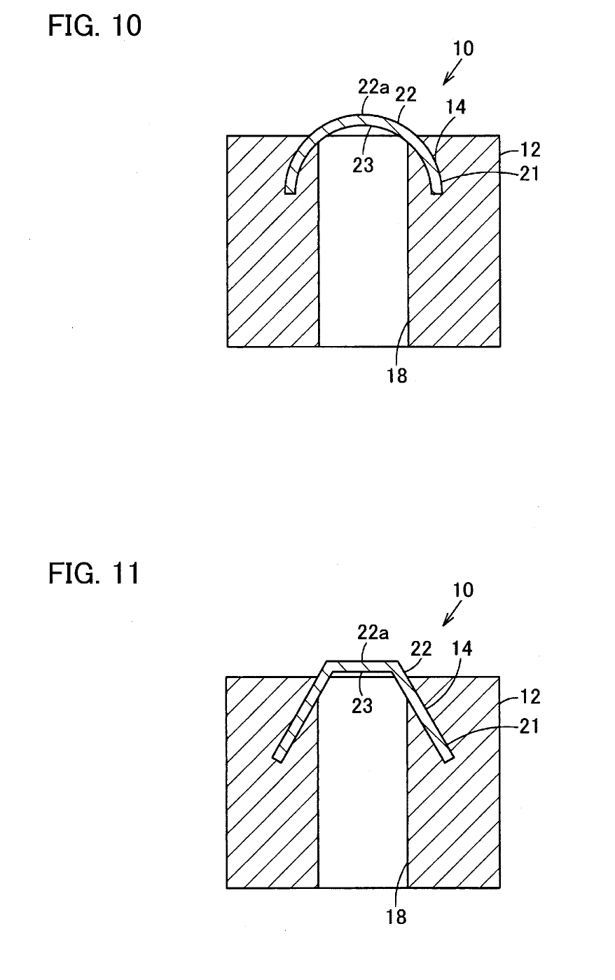

It should be noted that in the first embodiment described above, the cross section of the second member 14 of the composite component 10 is formed in a mountain shape, but for example, may be formed in an arcuate shape as in the second embodiment shown in FIG. 10, and may be formed in a trapezoidal shape as in the third embodiment shown in FIG. 11. In the case of forming the cross section in a trapezoidal shape, since the welding portion 22a has a flat shape, the fixing (welding) strength of the other component 15 can be further improved.

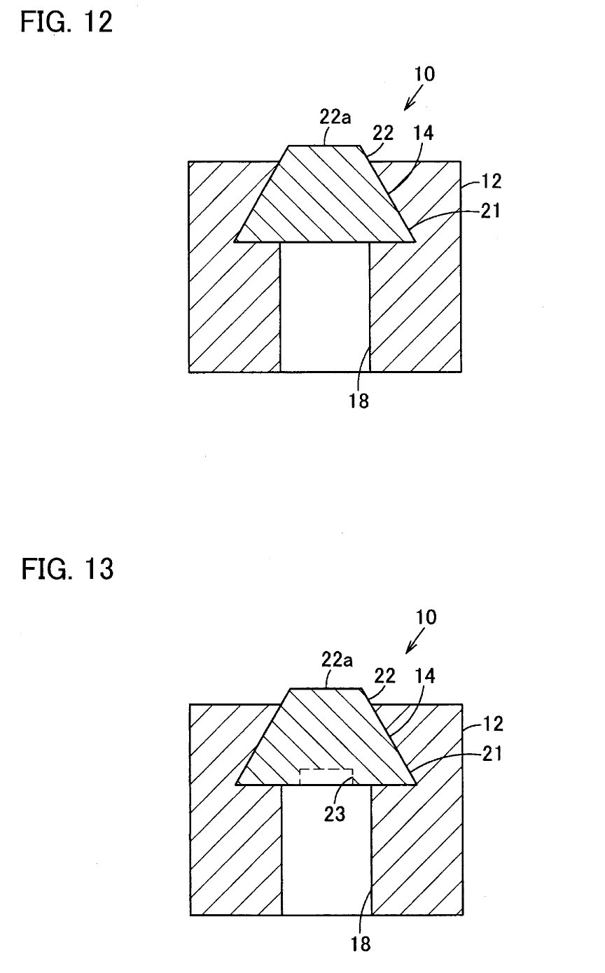

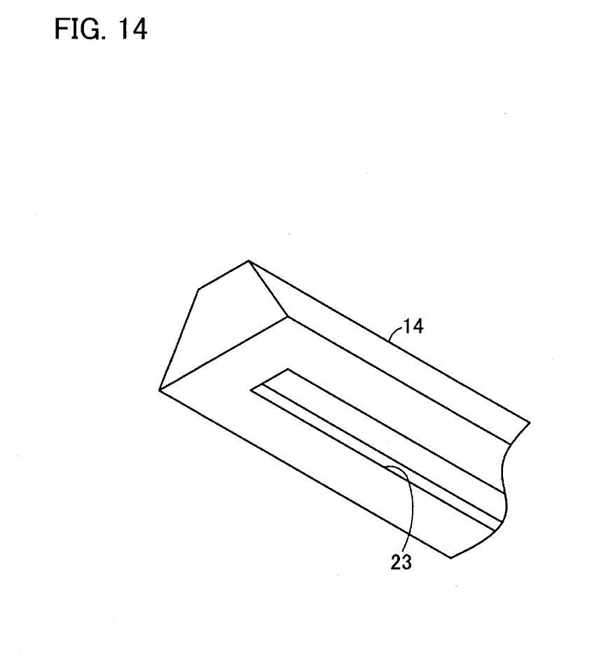

In addition, as in the fourth embodiment shown in FIG. 12, the second member 14 of the composite component 10 may have a solid shape, and as in the fifth embodiment shown in FIGS. 13 and 14, the second member 14 may have a shape that includes a recessed portion 23 only in a part thereof.

Furthermore, the second member 14 of the composite component 10 may have a rectangular shape or the like as long as the second member 14 can be held by the forming die 16.

Then, the composite component 10 of each of the embodiments described above can be used as any structure or the like besides those used as a vehicle structure.

The composite component according to one aspect of the present invention can be suitably used, for example, as a vehicle structure.

Embodiments of the present invention have been described above. However, the invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

Moreover, the effects described in the embodiments of the present invention are only a list of optimum effects achieved by the present invention. Hence, the effects of the present invention are not limited to those described in the embodiment of the present invention.

What is claimed is:

1. A composite component to be fixed to another component, the composite component comprising:
a first member formed of a first material; and
a second member formed of a second material different from the first material, the second member a part of which is covered with the first member,
wherein the second member includes a protruding portion protruding in a convex shape from the first member, and
wherein the protruding portion includes a fixing portion which is provided at least in a part of the protruding portion and to which the other component is to be fixed.

2. The composite component according to claim 1, wherein the second member includes a recessed portion on a back surface side of the protruding portion.

3. The composite component according to claim 1, wherein the composite component is a composite component for a vehicle.
